(19) United States
(12) Patent Application Publication
(10) Pub. No.: US 2026/0352950 A1
(43) Pub. Date: Nov. 5, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Keita KATO, Tokyo (JP)

(21) Appl. No.: 19/649,221

(22) Filed: Apr. 16, 2026

(30) Foreign Application Priority Data
May 2, 2025 (JP) 2025-076830

(51) Int. Cl. H04N 23/67; H04N 23/611

(52) U.S. Cl. CPC H04N 23/675; H04N 23/611; H04N 23/672

(57) ABSTRACT

In an image processing apparatus, image capturing information is acquired, a subject region is detected, a defocus state of the subject region is calculated as focus adjustment information, first focus adjustment information is determined based on the subject region and based on the focus adjustment information, a defocus range of the subject region and a reliability of the defocus range are estimated, and, in a case in which the reliability is equal to or greater than a first threshold, focus adjustment is performed by using the defocus range and by using the first focus adjustment information, and, in a case in which the reliability is less than the first threshold, focus adjustment is performed by using the first focus adjustment information without being based on the defocus range.

### BACKGROUND

### Field of the Technology

The present disclosure relates to an image processing apparatus, an image processing method, a storage medium, and the like.

### Description of the Related Art

A camera is known that is provided with a function that uses an image plane phase difference AF method employing an image capturing element, a contrast AF method, and the like, and that automatically adjusts a focus position of a photographic lens. Furthermore, there is a technology for specifying a main subject region to bring the main subject region into focus in a scene in which a plurality of subjects at different distances are intermixed at or near a main subject position.

In Japanese Patent Application Laid-Open No. 2022-186785, a method is proposed that specifies a peak value of a defocus amount within a subject region calculated from an image shift amount determined by correlation calculation of an AF signal, and, by determining a defocus amount to be used for focus adjustment, realizes suitable focus detection operation.

However, in the conventional technology disclosed in the above-described Japanese Patent Application Laid-Open No. 2022-186785, there was a problem that there is a possibility that focus adjustment is performed by using an unintended defocus amount in a case in which subjects other than the main subject, obstacles, and the like overlap extensively within the main subject region.

### SUMMARY

An image processing apparatus according to one aspect of the present disclosure is configured to: acquire image capturing information, detect a subject region, calculate a defocus state of the subject region as focus adjustment information, determine first focus adjustment information based on the subject region and based on the focus adjustment information, estimate a defocus range of the subject region and a reliability of the defocus range, and, in a case in which the reliability is equal to or greater than a first threshold, perform focus adjustment by using the defocus range and by using the first focus adjustment information, and, in a case in which the reliability is less than the first threshold, perform focus adjustment by using the first focus adjustment information without being based on the defocus range.

Further features of the present disclosure will become apparent from the following description of embodiments with reference to the attached drawings.

### BRIEF DESCRIPTION OF THE DRAWINGS

FIG. 1 is a diagram showing a configuration example of an image processing apparatus in the First Embodiment of the present disclosure.

FIG. 2 is a diagram for explaining a relationship between a defocus amount and an image shift amount in the First Embodiment.

FIGS. 3A and 3B are diagrams for explaining a defocus range in the First Embodiment.

FIG. 4 is a functional block diagram showing a configuration example of an image processing apparatus according to the First Embodiment.

FIG. 5 is a flowchart showing an example of a processing procedure for performing focus adjustment while switching focus adjustment information based on a reliability of a defocus range.

FIG. 6 is a diagram for explaining an overview of subject region detection in the First Embodiment.

FIG. 7 is a diagram for explaining an overview of focus adjustment information calculation region determination in the First Embodiment.

FIG. 8 is a flowchart showing an example of a processing procedure for performing determination of first focus adjustment information.

FIG. 9 is a flowchart showing an example of an operation flow of a neural network.

FIG. 10 is a diagram showing one example of estimation results of a defocus range and a reliability of the defocus range.

FIG. 11 is a flowchart showing an example of a processing procedure of an image processing method for performing determination of second focus adjustment information in the First Embodiment.

FIGS. 12A and 12B are diagrams for explaining an overview of second focus adjustment information determination in a case in which a reliability of a defocus range is high.

FIGS. 13A and 13B are diagrams for explaining an overview of second focus adjustment information determination in a case in which a reliability of a defocus range is moderate.

FIG. 14 is a functional block diagram showing a configuration example of an image processing apparatus according to the Second Embodiment.

FIG. 15 is a flowchart showing an example of a processing procedure for updating second focus adjustment information based on the first focus adjustment information and based on the second focus adjustment information, and performing focus adjustment based on the updated second focus adjustment information, in the Second Embodiment.

FIG. 16 is a flowchart showing an example of a processing procedure for performing determination of second focus adjustment information in step S4007 in the Second Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

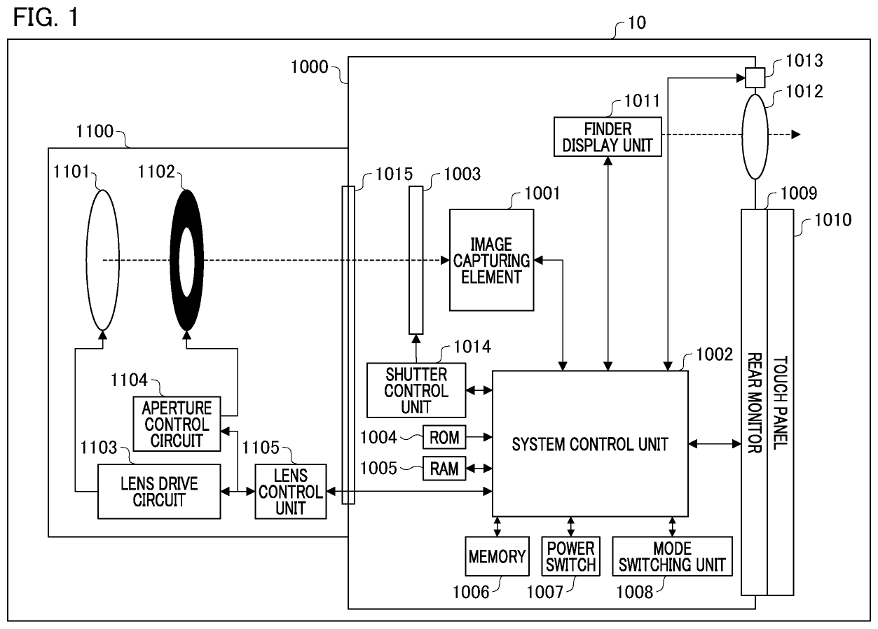

FIG. 1 is a diagram showing a configuration example of an image processing apparatus in the First Embodiment of the present disclosure. It should be noted that some of the functional blocks shown in FIG. 1 are realized by causing a CPU or the like serving as a computer included in the image processing apparatus to execute a computer program stored in a memory serving as a storage medium.

However, some or all of the functional blocks may be realized by hardware. As hardware, a dedicated circuit (ASIC), a processor (reconfigurable processor, DSP), or the like can be used.

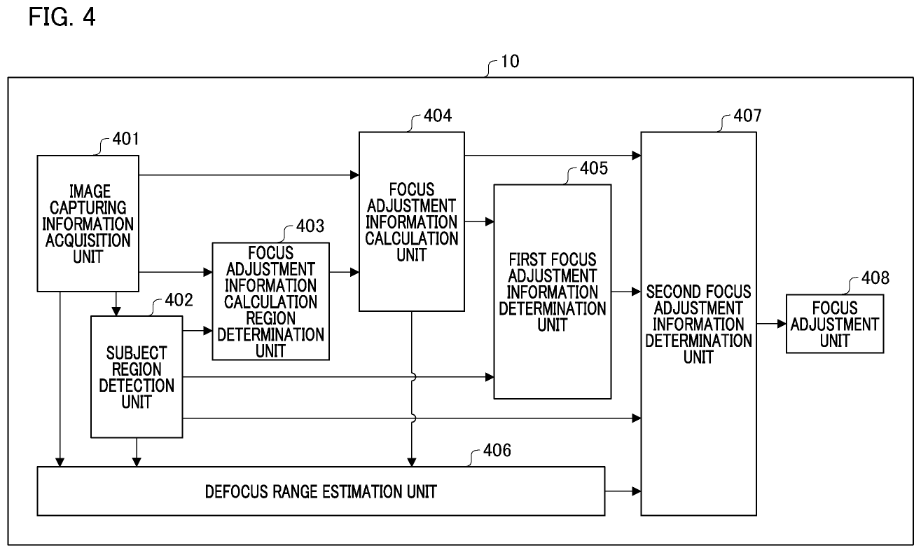

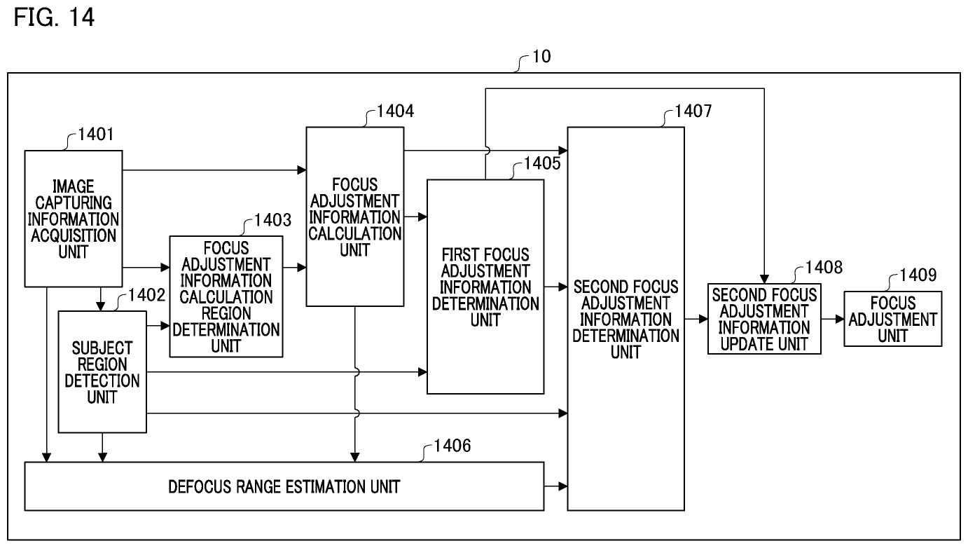

In addition, each of the functional blocks shown in FIG. 1 does not need to be housed in the same housing, and may be configured by separate apparatuses connected to each other via a signal path. It should be noted that the above-described explanation with respect to FIG. 1 similarly applies to FIG. 4 and FIG. 14.

The image processing apparatus 10 is, for example, an image capturing device or the like provided with an image capturing function, and is configured by a camera body 1000, a lens unit 1100 that guides incident light to an image capturing element 1001, and the like.

First, the camera body 1000 is explained. The image capturing element 1001 is configured by, for example, a CMOS image sensor, and converts an optical signal that is an optical image into an electrical signal. Light rays incident on a photographic lens 1101 form an image as an optical image on the image capturing element 1001 via an aperture 1102 and a shutter 1003.

A system control unit 1002 controls the camera body 1000, and includes a CPU or the like serving as a computer. The system control unit 1002 further includes an image processing unit for a video signal obtained from the image capturing element 1001. In addition, the system control unit 1002 further includes a phase difference AF unit that performs focus detection processing by a phase difference detection method based on focus detection image data (a signal for phase difference AF (Auto Focus)) obtained from the image capturing element 1001 and the image processing unit.

More specifically, the image processing unit generates, as focus detection image data, a pair of image data formed by light fluxes passing through a pair of pupil regions of an image capturing optical system. The phase difference AF unit detects a focus shift amount based on a shift amount (phase difference) of the above-described pair of image data.

In this manner, the phase difference AF unit of the present embodiment performs phase difference AF (image plane phase difference AF) based on an output of the image capturing element 1001 without using a dedicated AF sensor. A ROM 1004 functions as a storage medium that stores a computer program for controlling operation of the camera body 1000, a trained machine learning model, and the like.

A CPU serving as a computer within the system control unit 1002 functions as a control unit that controls operation of each unit of the entire image processing apparatus by executing a computer program stored in a storage medium such as the ROM 1004.

A RAM 1005 stores variables and setting values such as various parameters and ISO sensitivity that are necessary for operation of the camera body 1000, a live view image acquired during control, a shooting mode and various types of correction data, control information at a time of focus adjustment within a past predetermined time, and the like.

A memory 1006 is a removable flash memory, and stores captured images, various types of incidental information associated with captured images, and the like. A power switch 1007 switches between power-on and power-off modes of the camera body 1000.

A mode switching unit 1008 is a switch for switching and setting various shooting modes such as live view shooting, moving image shooting, and the like. A rear monitor 1009 is configured by a liquid crystal device, an LED, and the like, and displays shooting information such as operation states including characters, captured images, audio, and the like, and messages, and the like, in accordance with execution of a computer program in the system control unit 1002.

A touch panel 1010 is disposed in a region substantially equivalent to the rear monitor 1009, detects contact by a finger or a pen, notifies the system control unit 1002 of a contact position with respect to the rear monitor 1009, and executes an operation or function associated with the contact position.

A finder display unit 1011, similarly to the rear monitor 1009, displays shooting information in accordance with execution of a computer program by the system control unit 1002, and the finder display unit 1011 and an eyepiece lens 1012 configure an electronic viewfinder (EVF).

An eye proximity detection unit 1013 detects an eye proximity state of a photographer, and the system control unit 1002 selectively displays the above-described shooting information on the rear monitor 1009 or the finder display unit 1011 according to a detection result of the eye proximity detection unit 1013.

Next, a configuration of the lens unit 1100 is explained. The camera body 1000 and the lens unit 1100 are mechanically and electrically connectable via a lens mount mechanism 1015, and are detachable. The lens unit 1100 is configured by the photographic lens 1101, the aperture 1102, a lens drive circuit 1103, an aperture control circuit 1104, a lens control unit 1105, and the like.

Although only one photographic lens 1101 is shown in FIG. 1 for simplification, in actuality, the photographic lens 1101 is configured by a large number of photographic lens groups.

The lens control unit 1105 has a CPU serving as a computer, and controls the entire lens unit 1100. The lens control unit 1105 is provided with a memory (not shown) that stores various constants and variables for lens operation, a computer program, and the like. In addition, the lens control unit 1105 is provided with a nonvolatile memory that holds information unique to the lens unit, such as maximum and minimum aperture values, a focal length, and the like.

The system control unit 1002 of the camera body 1000 calculates a defocus amount by using output information of the image capturing element 1001. Then, the system control unit 1002 performs communication via the lens control unit 1105 of the lens unit 1100 based on the calculated defocus amount, and performs focus adjustment by controlling the lens drive circuit 1103.

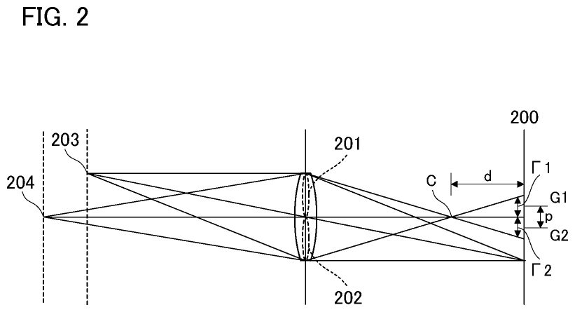

FIG. 2 is a diagram for explaining a relationship between a defocus amount and an image shift amount in the First Embodiment, and shows a relationship between a defocus amount of the image capturing optical system and a phase difference (image shift amount) between a first focus detection signal and a second focus detection signal, wherein the first focus detection signal and the second focus detection signal are acquired from an image capturing element.

An image plane 200 is a light receiving surface of an image capturing element (not shown), and an exit pupil of the image pickup capturing system is divided into a first pupil region 201 and a second pupil region 202. A defocus amount d corresponds to a distance (magnitude) from an image formation position C of a light flux from a subject (203, 204) to the image plane 200. FIG. 2 shows a front focus state (d<0) in which the image formation position C is on the subject side of the image plane 200.

In addition, in a rear focus state in which the image formation position C is on the opposite side of the image plane 200 from the subject, d>0, and in an in-focus state in which the image formation position C is on the image plane 200, d=0. In FIG. 2, the image capturing optical system is in an in-focus state (d=0) with respect to the subject 203, and is in a front focus state (d<0) with respect to the subject 204. The front focus state (d<0) and the rear focus state (d>0) are collectively referred to as a defocus state (|d|>0).

In the front focus state (d<0), of the light flux from the subject 204, the light flux that has passed through the first pupil region 201 (the second pupil region 202) first converges, and then spreads by a width Γ1 (Γ2) centered on a centroid position G1 (G2) of the light flux, and forms a blurred image on the image plane 200.

This blurred image is received by first focus detection pixels (each second focus detection pixel) included in each pixel of the image capturing element, and a first focus detection signal (second focus detection signal) is generated. That is, the first focus detection signal (second focus detection signal) is a signal representing a subject image of the subject 204 blurred by a blur width Γ1 (Γ2) at the centroid position G1 (G2) of the light flux on the image plane 200.

A blur width Γ1 (Γ2) of the subject image increases approximately in proportion to an increase in a magnitude |d| of the defocus amount d. Similarly, a magnitude |p| of an image shift amount p (=difference G1−G2 between centroid positions of light fluxes) between the first focus detection signal and the second focus detection signal also increases approximately in proportion to an increase in the magnitude |d| of the defocus amount d. Even in a rear focus state (d>0), although the image shift direction between the first focus detection signal and the second focus detection signal becomes opposite to the image shift direction in the front focus state, the same applies.

In this manner, the image shift amount between the first and second focus detection signals increases as the defocus amount increases. In the present embodiment, focus detection by an image plane phase difference detection method is performed by using the image processing apparatus 10 to calculate a defocus amount based on an image shift amount between the first focus detection signal and the second focus detection signal.

That is, based on a relationship in which a defocus amount increases in accordance with an increase in an image shift amount between the first focus detection signal and the second focus detection signal, the image shift amount is converted to a defocus amount by a conversion coefficient calculated based on a baseline length. It should be noted that in the present embodiment, a product [Fδ] of an aperture F-number and an allowable circle of confusion diameter 6 in an optical system of an image capturing apparatus at a time of image capturing is used as a unit of defocus amount.

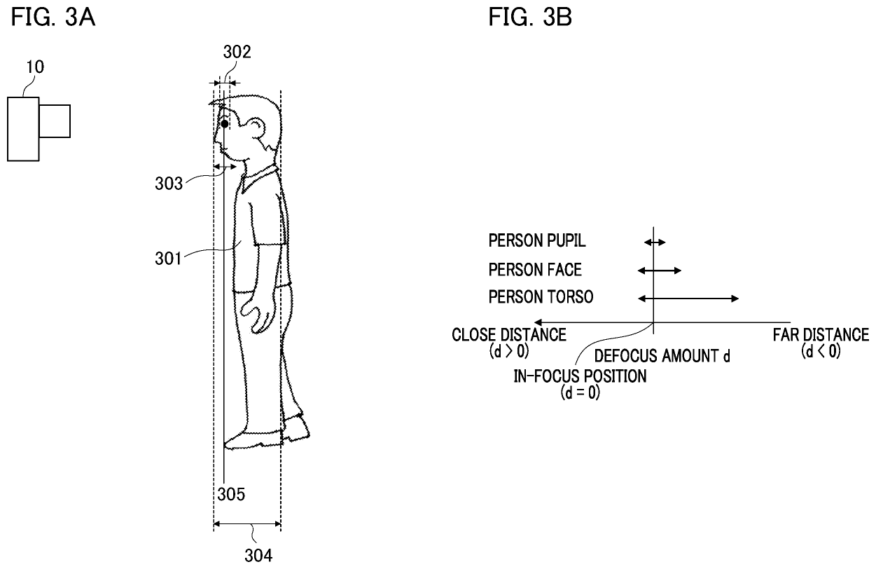

Continuing, FIGS. 3A and 3B are diagrams for explaining a defocus range in the First Embodiment, and FIG. 3A illustrates a state in which image capturing of a person 301 is performed by using the image processing apparatus 10. Reference numeral 302 denotes a distance range (defocus range) from the image processing apparatus 10 to a pupil of the person, reference numeral 303 denotes a distance range (defocus range) from the image processing apparatus 10 to a face of the person, and reference numeral 304 denotes a distance range (defocus range) from the image processing apparatus 10 to a full body of the person.

Reference numeral 305 indicates that an in-focus position in the image processing apparatus 10 is within the distance range (defocus range) 302 of the pupil of the person. In addition, FIG. 3B is a schematic diagram showing defocus ranges 302, 303, and 304 of the pupil, the face, and the full body of the person, in which a horizontal axis direction represents a magnitude of the defocus amount d, and a side closer to the image processing apparatus 10 is defined as close distance, and a farther side is defined as far distance. A length of each line segment represents a defocus range that is a range of values of defocus amount.

It should be noted that in a case in which a user inputs ground truth data of a defocus range in advance, a maximum value (closest-distance value) and a minimum value (farthest-distance value) of the defocus amount may be input for each part such as a pupil, a face, and a full body.

It should be noted that although explanation was given here using defocus ranges of a pupil, a face, and a full body of a person as an example, there is no constraint on a target subject or part, and the present embodiment is not limited to this example.

In the First Embodiment, suitable focus detection operation is realized by using, for focus adjustment, focus adjustment information having different determination methods while the focus adjustment information is switched based on a reliability of a defocus range.

FIG. 4 is a functional block diagram showing a configuration example of an image processing apparatus according to the First Embodiment. The image processing apparatus 10 has an image capturing information acquisition unit 401, a subject region detection unit 402, a focus adjustment information calculation region determination unit 403, a focus adjustment information calculation unit 404, and a first focus adjustment information determination unit 405. Furthermore, the image processing apparatus 10 is provided with a defocus range estimation unit 406, a second focus adjustment information determination unit 407, and a focus adjustment unit 408. However, FIG. 4 is one example of a functional configuration example, and the function of the present embodiment is not limited thereto.

The image capturing information acquisition unit 401 acquires focus detection image data (a signal for phase difference AF) acquired from the image capturing element 1001 and an image corresponding to the focus detection image data as image capturing information. Then, the image capturing information acquisition unit 401 outputs the image capturing information to the subject region detection unit 402, the focus adjustment information calculation region determination unit 403, the focus adjustment information calculation unit 404, and the defocus range estimation unit 406.

The subject region detection unit 402 performs detection of a subject region with respect to an image included in the received image capturing information. Then, the subject region detection unit 402 outputs a subject region detection result to the focus adjustment information calculation region determination unit 403, the first focus adjustment information determination unit 405, the defocus range estimation unit 406, and the second focus adjustment information determination unit 407.

The focus adjustment information calculation region determination unit 403 determines a focus adjustment information calculation region based on the received image capturing information and the subject region detection result. Then, the focus adjustment information calculation region determination unit 403 outputs the focus adjustment information calculation region to the focus adjustment information calculation unit 404.

The focus adjustment information calculation unit 404 calculates a defocus amount based on focus detection image data included in the received image capturing information and the focus adjustment information calculation region. That is, the focus adjustment information calculation unit 404 calculates a defocus state of the subject region as focus adjustment information. Then, the focus adjustment information calculation unit 404 outputs a focus adjustment information calculation result to the first focus adjustment information determination unit 405, the defocus range estimation unit 406, and the second focus adjustment information determination unit 407.

The first focus adjustment information determination unit 405 determines a focus adjustment target part such as a pupil, a face, or a full body, and first focus adjustment information indicating a defocus amount serving as a candidate to be used for focus adjustment. That is, the first focus adjustment information determination unit 405 determines first focus adjustment information based on the subject region and based on the focus adjustment information. Then, the first focus adjustment information determination unit 405 outputs the focus adjustment target part and the first focus adjustment information to the second focus adjustment information determination unit 407.

The defocus range estimation unit 406 estimates a defocus range of a subject and a reliability of the defocus range based on an image included in the image capturing information, based on the subject region detection result, and based on the focus adjustment information calculation result. That is, the defocus range estimation unit 406 estimates a defocus range of the subject region and a reliability of the defocus range. Then, the defocus range estimation unit 406 outputs a defocus range estimation result to the second focus adjustment information determination unit 407.

The second focus adjustment information determination unit 407 determines a defocus amount serving as a candidate to be used for focus adjustment as second focus adjustment information. Then, the second focus adjustment information determination unit 407 outputs the second focus adjustment information to the focus adjustment unit 408. The focus adjustment unit 408 performs focus adjustment based on the received second focus adjustment information.

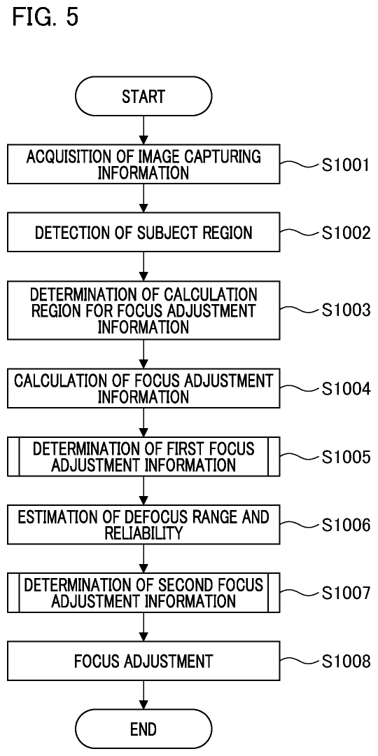

Next, a processing procedure in the present embodiment is explained. FIG. 5 is a flowchart showing an example of a processing procedure for performing focus adjustment while switching focus adjustment information based on a reliability of a defocus range.

It should be noted that operations of each step in the flowchart in FIG. 5 are sequentially performed by a CPU or the like serving as a computer within the system control unit 1002 executing a computer program stored in a memory. However, the image processing apparatus 10 does not necessarily need to perform all of the steps explained in this flowchart.

Step S1001 functions as an image capturing information acquisition step, and the image capturing information acquisition unit 401 acquires, as image capturing information, focus detection image data (a signal for phase difference AF) acquired from the image capturing element 1001, and an image corresponding to the focus detection image data. However, the type of information to be acquired is not limited thereto, and focus detection image data and an image may be received as two separate pieces of data, or a plurality of pieces of image capturing information may be received as continuous time-series data.

The received image capturing information is output to the subject region detection unit 402, the focus adjustment information calculation region determination unit 403, the focus adjustment information calculation unit 404, and the defocus range estimation unit 406, and the processing proceeds to step S1002.

Step S1002 functions as a subject region detection step for detecting a subject region, and the subject region detection unit 402 performs detection of a subject region with respect to an image included in the received image capturing information. As a method for detecting a subject region, for example, a Bounding Box (hereinafter abbreviated as BB) indicating a center position and a size is detected for a pupil of a person in an image, a face of the person, and a full body of the person, the pupil, the face, and the full body serving as subject regions.

In this manner, the subject region detection unit 402 of the present embodiment detects at least one of a pupil of a subject, a face of the subject, and a full body of the subject as a subject region. It should be noted that Non-Patent Document 1 (Liu, SSD: Single Shot Multibox Detector. In: ECCV2016) is an example of a technology for detecting a BB of an object from within an image, and Non-Patent Document 2 (RetinaFace: Single-stage Dense Face Localisation in the Wild. In: arXiv2019) is an example of a technology for detecting a face and a pupil.

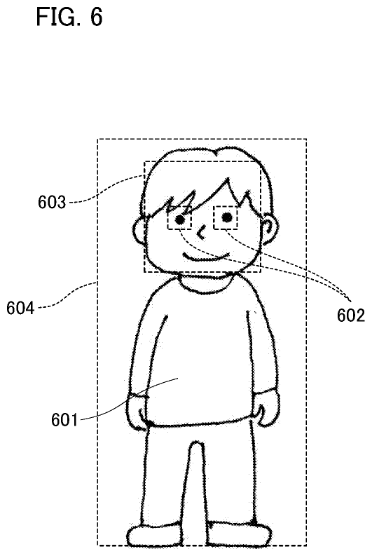

FIG. 6 is a diagram for explaining an overview of subject region detection in the First Embodiment. Reference numeral 601 denotes a person that is a detection target of subject region detection, reference numeral 602 denotes one example of a BB of a pupil detected as a subject region, reference numeral 603 denotes one example of a BB of a face detected as a subject region, and reference numeral 604 denotes one example of a BB of a full body detected as a subject region.

It should be noted that although a method for detecting a subject region of a person as a BB using the technology of Non-Patent Document 1 or Non-Patent Document 2 was shown here as one example, there is no constraint on a subject region detection method. Subject region detection may be performed by using different detection methods with respect to any object such as an animal or a vehicle.

In step S1002, the subject region detection result is output to the focus adjustment information calculation region determination unit 403, the first focus adjustment information determination unit 405, the defocus range estimation unit 406, and the second focus adjustment information determination unit 407, and the processing proceeds to step S1003.

In step S1003, the focus adjustment information calculation region determination unit 403 determines one or more focus adjustment information calculation regions for calculating a defocus amount that is focus adjustment information, based on an image included in the received image capturing information and the subject region detection result.

As a method for determining a focus adjustment information calculation region, for example, from the subject region detection result, a size of a focus adjustment information calculation region is set based on a horizontal size and a vertical size of a minimum detection region such as a pupil.

Then, one or more focus adjustment information calculation regions are determined by disposing the focus adjustment information calculation region set as described above in a form in which all other subject regions such as a face and a full body, and the like, are encompassed.

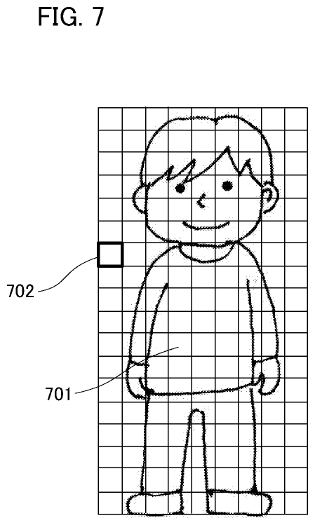

FIG. 7 is a diagram for explaining an overview of focus adjustment information calculation region determination in the First Embodiment. Reference numeral 701 denotes a person that is a detection target of a focus adjustment information calculation region, and reference numeral 702 denotes one example of a determined focus adjustment information calculation region.

It should be noted that although a method for setting the smaller of a horizontal size and a vertical size of a minimum detection region as a frame size of a focus adjustment information calculation region based on a subject region detection result of a person was shown here as one example, there is no constraint on a focus adjustment information calculation region determination method.

A focus adjustment information calculation region may be determined based on a subject region detection result of any object such as an animal or a vehicle. In addition, the focus adjustment information calculation region may be a predetermined focus adjustment information calculation region without using a subject region detection result.

In step S1003, the focus adjustment information calculation region is output to the focus adjustment information calculation unit 404, and the processing proceeds to step S1004.

In step S1004, the focus adjustment information calculation unit 404 calculates focus adjustment information (defocus amount) based on focus detection image data included in the image capturing information received by the focus adjustment information calculation unit 404, and the focus adjustment information calculation region. In this context, step S1004 functions as a focus adjustment information calculation step for calculating a defocus state of the subject region as focus adjustment information.

As a method for calculating focus adjustment information, for example, a pair of image signals (an A image signal and a B image signal) for focus detection from the image capturing element 1001 is acquired for a plurality of rows, and the A image signal and the B image signal of the acquired pair of image signals for the plurality of rows are averaged by addition in a vertical direction for noise reduction.

Then, filter processing is performed to extract, from each of the pair of image signals respectively averaged by addition in the vertical direction, respective signal components of predetermined frequency bands, and signal components of a plurality of frequency bands (high band, medium band, low band) are extracted. Furthermore, a correlation amount is calculated from the extracted pair of image signals, and a correlation change amount is calculated from the calculation result.

Finally, an image shift amount is calculated from the correlation change amount, and the image shift amount is converted to a defocus amount, and thereby a defocus amount is calculated in units of the focus adjustment information calculation region. It should be noted that although a method for calculating a defocus amount from a pair of image signals for focus detection was explained here as one example, there is no constraint on a focus adjustment information calculation method.

In step S1004, the focus adjustment information calculation result is output to the first focus adjustment information determination unit 405, the defocus range estimation unit 406, and the second focus adjustment information determination unit 407, and the processing proceeds to step S1005.

In step S1005, the first focus adjustment information determination unit 405 determines a focus adjustment target part such as a pupil, a face, or a full body, and first focus adjustment information indicating a defocus amount serving as a candidate to be used for focus adjustment.

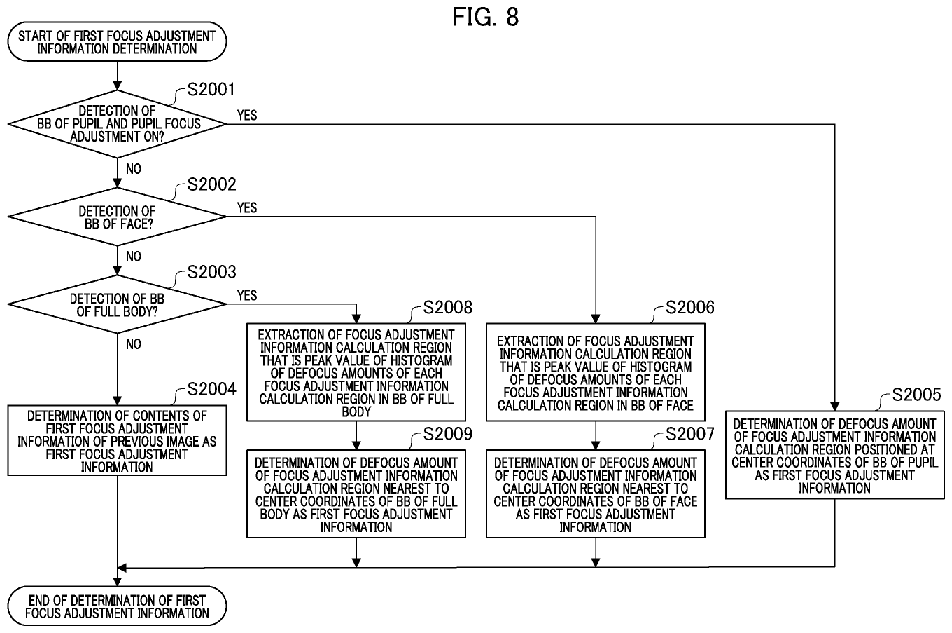

In this context, step S1005 functions as a first focus adjustment information determination step for determining first focus adjustment information based on the subject region and the focus adjustment information. It should be noted that details of determination of the first focus adjustment information are described below by using FIG. 8.

It should be noted that here, as one example, first focus adjustment information is determined based on center coordinates of a BB and a peak value of a histogram of defocus amounts. That is, the first focus adjustment information determination unit determines first focus adjustment information based on center coordinates of the subject region or based on the histogram of focus adjustment information.

However, there is no constraint on a method for determining first focus adjustment information. For example, first focus adjustment information may be determined by statistical prediction from first focus adjustment information at a past time, or a closest-distance or farthest-distance defocus amount may be determined as first focus adjustment information.

In step S1005, the focus adjustment target part and the first focus adjustment information are output to the second focus adjustment information determination unit 407, and the processing proceeds to step S1006.

In step S1006, the defocus range estimation unit 406 estimates a defocus range of at least one of a pupil of a subject, a face of the subject, and a full body of the subject, and estimates a reliability of the defocus range.

That is, the defocus range estimation unit estimates a defocus range of at least one of a pupil of a subject, a face of the subject, and a full body of the subject, and a reliability of the defocus range. In this context, step S1006 functions as a defocus range estimation step for estimating a defocus range of the subject region and a reliability of the defocus range.

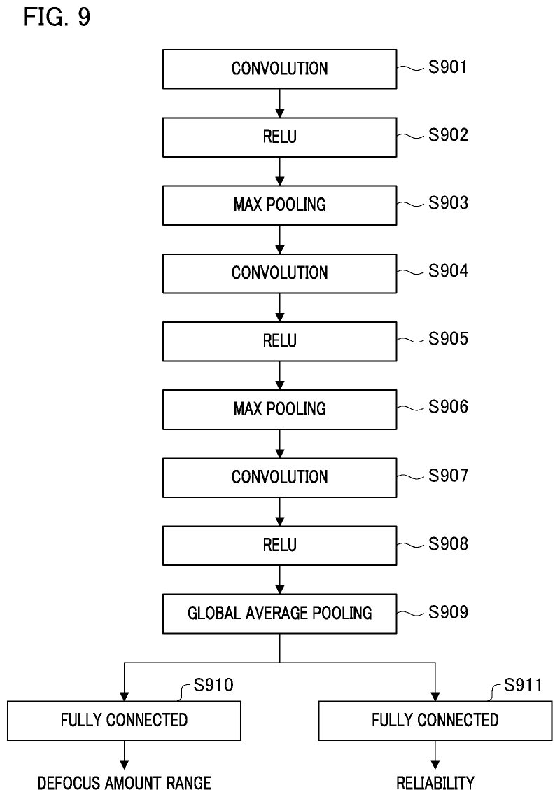

As a method for estimating a defocus range and a reliability of the defocus range, for example, a Neural Network (hereinafter abbreviated as NN) shown in FIG. 9 is used.

FIG. 9 is a flowchart showing an example of an operation flow of a Neural Network. It should be noted that operations of each step in the flowchart in FIG. 9 are sequentially performed by a CPU or the like serving as a computer within the system control unit 1002 executing a computer program stored in a memory.

An image, a subject region detection result, and a focus adjustment information calculation result are input to the NN. Then, a defocus range and a reliability of the defocus range are estimated by an NN configuration in which NN weights are shared between defocus range estimation and reliability estimation.

It should be noted that the NN performs a plurality of Convolutions (convolution calculations) in step S901, step S904, step S907, and the like. In addition, the NN performs ReLU in step S902, step S905, and step S908.

In addition, the NN performs non-linear calculations such as Max Pooling in step S903 and step S906, and Global Average Pooling in step S909. In addition, the NN performs Fully Connected processing (full connection) in step S910 and step S911.

That is, as a processing flow of the NN, after repeating Convolution, ReLU, and Max Pooling a plurality of times, information in a spatial direction is compressed by Global Average Pooling.

Finally, a desired channel is obtained by Fully Connected. It should be noted that Multilayer Perceptron may be used instead of Convolution, or Multi-head Self Attention may be used.

In addition, as a learning method of an NN used for estimation of a defocus range and a reliability of the defocus range, for example, an image, a subject region detection result corresponding to the image, and a focus adjustment information calculation result are input as input data.

In addition, a defocus range and a reliability of the defocus range are estimated by an NN having a configuration as shown in FIG. 9. Then, the learning of the NN is performed by updating parameters based on a loss calculated from the estimation result and ground truth data.

It should be noted that as for ground truth data of a defocus range, a maximum defocus amount on a close distance side and a minimum defocus amount on a far distance side are defined for each part of a subject in association with an image of input data. In addition, ground truth data of a reliability of a defocus range is set as appropriate based on the estimation result of the defocus range and ground truth data. Specifically, if the defocus range result and the ground truth data are close, a continuous value having high reliability is set.

It should be noted that although an example of learning and estimating a defocus range and a reliability using the NN model shown in FIG. 9 was explained here, the present embodiment is not limited to the example shown in FIG. 9. A program that calculates a defocus range and a reliability in accordance with an NN model having a different configuration or a predetermined algorithm may be used.

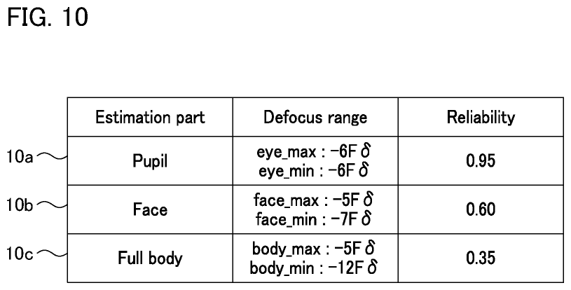

FIG. 10 is a diagram showing one example of estimation results of a defocus range and a reliability of the defocus range, and shows one example of estimation results of a defocus range and a reliability of the defocus range with respect to a pupil of a subject, a face of the subject, and a full body of the subject.

Reference numeral 10a in FIG. 10 shows one example of an estimation result of a defocus range of a pupil and an estimation result of a reliability of the defocus range of the pupil, and reference numeral 10b shows one example of an estimation result of a defocus range of a face and an estimation result of a reliability of the defocus range of the face. Reference numeral 10c shows one example of an estimation result of a defocus range of a full body and an estimation result of a reliability of the defocus range of the full body.

In step S1006, the estimation results of the defocus range and the reliability are output to the second focus adjustment information determination unit 407, and the processing proceeds to step S1007.

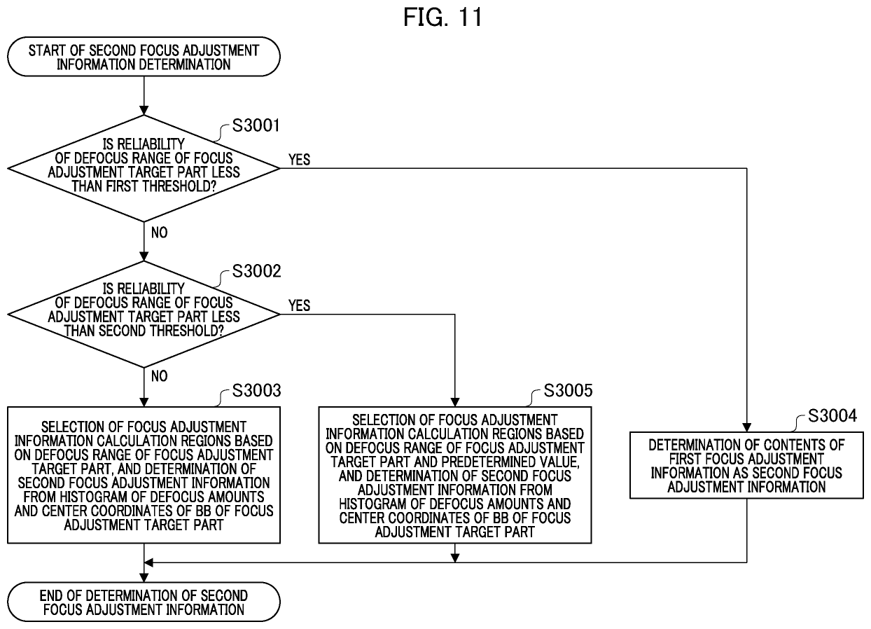

In step S1007, the second focus adjustment information determination unit 407 determines, as the second focus adjustment information, a defocus amount serving as a candidate to be used for focus adjustment. That is, the second focus adjustment information includes a defocus amount that serves as a candidate to be used for focus adjustment. Details of determination of the second focus adjustment information in step S1007 are described below by using FIG. 11.

In step S1007, the second focus adjustment information is output to the focus adjustment unit 408, and the processing proceeds to step S1008.

In step S1008, the focus adjustment unit 408 calculates a focus lens drive amount based on the defocus amount of the received second focus adjustment information. Then, the focus adjustment unit 408 drives the focus lens (image capturing control) based on the calculated focus lens drive amount. Then, processing ends. The processing flow of FIG. 5 is executed, for example, each time a release button of a camera serving as an image capturing apparatus is pressed.

By the above-described processing, focus adjustment can be performed while focus adjustment information is switched based on the reliability of the defocus range.

Next, details of determination of the focus adjustment target part and the first focus adjustment information in step S1005 are explained below by using FIG. 8.

FIG. 8 is a flowchart showing an example of a processing procedure for performing determination of the first focus adjustment information. It should be noted that operations of each step in the flowchart in FIG. 8 are sequentially performed by a CPU or the like serving as a computer within the system control unit 1002 executing a computer program stored in a memory.

In step S2001 in FIG. 8, the first focus adjustment information determination unit 405 determines, based on the received subject region detection result, whether a BB of a pupil has been detected. Furthermore, the first focus adjustment information determination unit 405 determines, based on a camera setting value recorded in the RAM 1005, whether a setting to adjust focus on the pupil is set to on.

In addition, in a case in which the BB of the pupil has been detected and a setting to adjust focus on the pupil is enabled, the pupil is determined as the focus adjustment target part. It should be noted that although determination is made here based on detection of the BB of the pupil and presence or absence of the focus adjustment setting for the pupil, determination may be made based only on presence or absence of detection of the BB of the pupil.

Then, in a case in which a determination is made that the BB of the pupil has been detected and further the setting to adjust focus on the pupil is enabled, the processing proceeds to step S2005. In a case other than the above, the processing proceeds to step S2002.

In step S2002, the first focus adjustment information determination unit 405 determines, based on the received subject region detection result, whether a BB of a face has been detected. In addition, in a case in which the BB of the face has been detected, the face is determined as the focus adjustment target part.

Then, in a case in which a determination is made that the BB of the face has been detected, the processing proceeds to step S2006. In a case in which a determination is made that the BB of the face has not been detected, the processing proceeds to step S2003.

In step S2003, the first focus adjustment information determination unit 405 determines, based on the received subject region detection result, whether a BB of a full body has been detected. In addition, in a case in which the BB of the full body has been detected, the full body is determined as the focus adjustment target part.

Then, in a case in which a determination is made that the BB of the full body has been detected, the processing proceeds to step S2008. In a case in which a determination is made that the BB of the full body has not been detected, the processing proceeds to step S2004.

In step S2004, based on control information at a time of focus adjustment within a past predetermined time, the first focus adjustment information determination unit 405 determines contents of the first focus adjustment information determined based on an immediately preceding past image as the first focus adjustment information of a current image.

It should be noted that, although an example of using the first focus adjustment information determined based on an immediately preceding past image is shown here as one example, there is no constraint on a method for utilizing the first focus adjustment information of a past image.

That is, determination of the first focus adjustment information may be performed based on a transition of change in the first focus adjustment information of a plurality of past images and statistical processing (for example, averaging processing), or contents of the first focus adjustment information of a past image from N time points before may be determined as the first focus adjustment information of a current image. Then, processing ends.

In step S2005, the first focus adjustment information determination unit 405 determines a defocus amount of a focus adjustment information calculation region nearest to center coordinates of the BB of the pupil as the first focus adjustment information, based on the subject region detection result and a focus adjustment information calculation result. Then, the processing flow of FIG. 8 ends.

In step S2006, the first focus adjustment information determination unit 405 generates a histogram from defocus amounts of each focus adjustment information calculation region in the BB of the face, and extracts a focus adjustment information calculation region corresponding to the peak value of the histogram. Then, the processing proceeds to step S2007.

In step S2007, the first focus adjustment information determination unit 405 determines, among focus adjustment information calculation regions corresponding to the above-described histogram peak value, a defocus amount of a focus adjustment information calculation region nearest to center coordinates of the BB of the face as the first focus adjustment information. Then, the processing flow of FIG. 8 ends.

In step S2008, the first focus adjustment information determination unit 405 extracts a focus adjustment information calculation region corresponding to the peak value of a histogram generated from defocus amounts of each focus adjustment information calculation region in the BB of the full body. Then, the processing proceeds to step S2009.

In step S2009, the first focus adjustment information determination unit 405 determines, among focus adjustment information calculation regions corresponding to the above-described histogram peak value, a defocus amount of a focus adjustment information calculation region nearest to center coordinates of the BB of the full body as the first focus adjustment information. Then, the processing flow of FIG. 8 ends.

By a processing flow such as that described above, the first focus adjustment information can be determined by using the first focus adjustment information determination unit 405.

Next, details of determination of the second focus adjustment information in step S1007 in FIG. 5 are explained below by using FIG. 11.

FIG. 11 is a flowchart showing an example of a processing procedure of an image processing method for performing determination of the second focus adjustment information in the First Embodiment. It should be noted that operations of each step in the flowchart in FIG. 11 are sequentially performed by a CPU or the like serving as a computer within the system control unit 1002 executing a computer program stored in a memory.

In step S3001 in FIG. 11, in order to determine whether reliability of a defocus range of a part that is a focus adjustment target is low, the second focus adjustment information determination unit 407 makes a determination as to whether or not the reliability is less than a first threshold. In a case in which a determination is made that the reliability is less than the first threshold, the processing proceeds to step S3004. In a case in which the reliability exceeds the first threshold, the processing proceeds to step S3002.

In step S3002, in order to determine whether reliability of the defocus range of the part that is the focus adjustment target is at a medium level, the second focus adjustment information determination unit 407 makes a determination as to whether or not the reliability is less than a second threshold. In a case in which a determination is made that the reliability is less than the second threshold, the processing proceeds to step S3005. In a case in which the reliability exceeds the second threshold, the processing proceeds to step S3003.

In step S3003, the second focus adjustment information determination unit 407 performs selection of focus adjustment information calculation regions based on the defocus range of the part that is the focus adjustment target. In addition, the second focus adjustment information determination unit 407 determines the second focus adjustment information from a peak value of a histogram of defocus amounts of each focus adjustment information calculation region after selection and from center coordinates of the BB of the focus adjustment target part.

That is, in a case in which the reliability of the defocus range is equal to or greater than a second threshold that is greater than a first threshold, the second focus adjustment information is determined based on the defocus range, based on a histogram of defocus amounts, and based on center coordinates of a subject region.

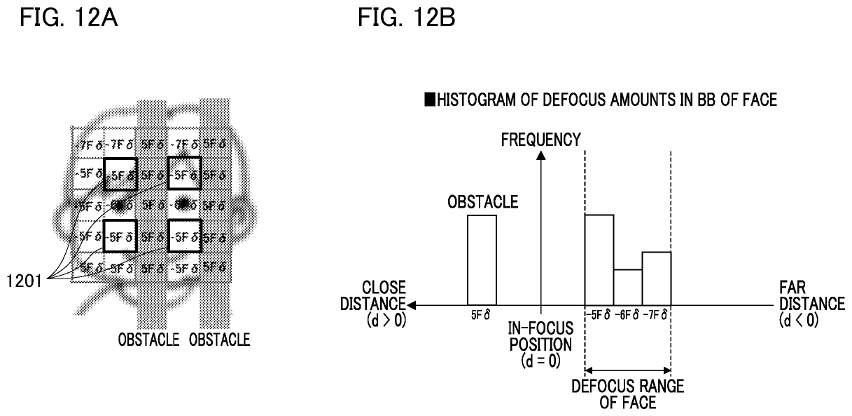

Hereinafter, one specific example of a method for determining the second focus adjustment information in step S3003 is explained in detail by using FIG. 12.

FIG. 12A and FIG. 12B are diagrams for explaining an overview of determination of the second focus adjustment information in a case in which reliability of the defocus range is high. FIG. 12A illustrates, in a scene in which an obstacle exists in the foreground, one example of each focus adjustment information calculation region in the BB of the face of a person and a defocus amount.

In addition, FIG. 12B illustrates one example of a histogram of defocus amounts of each focus adjustment information calculation region in the BB of the face and an estimation result of the defocus range of the face. When determining the second focus adjustment information, focus adjustment information calculation regions for which defocus amounts of −5Fδ to −7Fδ within the high-reliability defocus range of the face in FIG. 12B have been calculated are selected.

Then, among focus adjustment information calculation regions of −5Fδ, −5Fδ being the peak value of the defocus amounts, a defocus amount of the four focus adjustment information calculation regions 1201 nearest to the center coordinates of the BB of the face is determined as the second focus adjustment information.

It should be noted that, although here the four focus adjustment information calculation regions serve as candidates for the second focus adjustment information, since all the four focus adjustment information calculation regions show the same defocus amount, in step S3003, the defocus amount is determined as the second focus adjustment information. Then, the processing flow of FIG. 11 ends.

In step S3004, the second focus adjustment information determination unit 407 determines contents of the first focus adjustment information without modification as the second focus adjustment information. Then, the processing flow of FIG. 11 ends.

In step S3005, the second focus adjustment information determination unit 407 performs selection of focus adjustment information calculation regions based on the defocus range and a predetermined value indicating an allowable width of a defocus amount serving as a candidate to be used at a time of focus adjustment. In addition, the second focus adjustment information determination unit 407 determines the second focus adjustment information from a peak value of a histogram of defocus amounts of each focus adjustment information calculation region after selection and from center coordinates of the BB of the focus adjustment target part.

That is, in a case in which the reliability of the defocus range is greater than a first threshold and less than a second threshold that is greater than the first threshold, selection of focus adjustment information is performed based on the defocus range and a predetermined value. Then, the second focus adjustment information is determined based on a selection result, based on a histogram of defocus amounts, and based on center coordinates of a subject region. In this context, step S3001 to step S3005 function as a focus adjustment step for performing focus adjustment by performing the above-described processing.

It should be noted that, by this processing, the defocus range having medium reliability is utilized, and erroneously performing focus adjustment by using a defocus amount of an obstacle greatly separated in the depth direction from a main subject can be prevented.

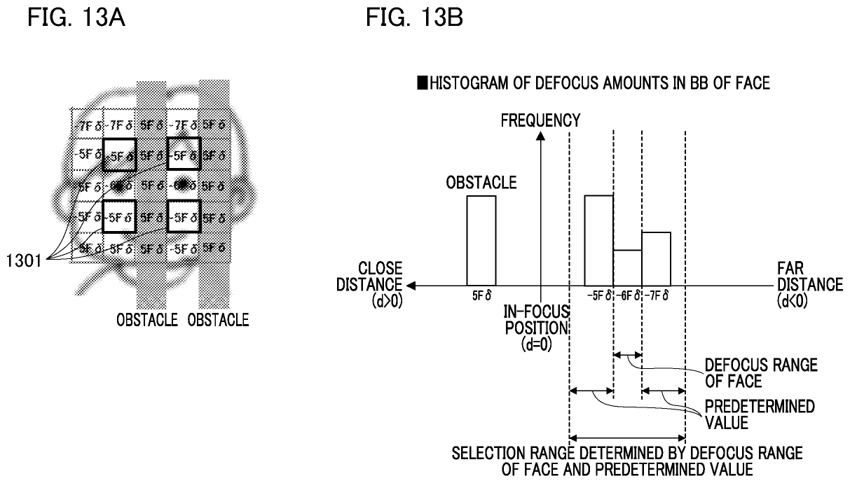

Hereinafter, one specific example of a method for determining the second focus adjustment information in step S3005 is explained in detail by using FIG. 13.

FIG. 13A and FIG. 13B are diagrams for explaining an overview of determination of the second focus adjustment information in a case in which reliability of the defocus range is at a medium level.

FIG. 13A shows, in a scene in which an obstacle exists in the foreground, one example of each focus adjustment information calculation region in the BB of the face of a person and a defocus amount. FIG. 13B shows one example of a histogram of defocus amounts of each focus adjustment information calculation region in the BB of the face, an estimation result of the defocus range of the face, and a selection range determined by the defocus range of the face and a predetermined value.

In step S3005, as determination of the second focus adjustment information, a selection range of focus adjustment information calculation regions is determined based on the medium-reliability defocus range of the face in FIG. 13B and a predetermined value set in advance. Thereafter, focus adjustment information calculation regions in which defocus amounts of −5Fδ to −7Fδ within the selection range determined by the defocus range of the face and the predetermined value have been calculated are selected.

Then, in step S3005, among focus adjustment information calculation regions of −5Fδ, −5Fδ being the peak value of the defocus amounts, a defocus amount of the four focus adjustment information calculation regions 1301 nearest to the center coordinates of the BB of the face is determined as the second focus adjustment information.

It should be noted that, although the four focus adjustment information calculation regions serve as candidates for the second focus adjustment information here, since all the four focus adjustment information calculation regions show the same defocus amount, the defocus amount is determined as the second focus adjustment information. Then, the processing flow of FIG. 11 ends.

By the above-described processing, the second focus adjustment information can be determined by using the second focus adjustment information determination unit 407.

In this manner, in a case in which the reliability of the defocus range is equal to or greater than the first threshold, the focus adjustment unit of the present embodiment performs focus adjustment by using the defocus range and by using the first focus adjustment information in step S3003 or step S3005. In contrast, in a case in which the reliability of the defocus range is less than the first threshold, focus adjustment is performed by using the first focus adjustment information without being based on the defocus range in step S3004.

More specifically, in a case in which the reliability of the defocus range is equal to or greater than a predetermined value, the second focus adjustment information determination unit generates the second focus adjustment information based on the defocus range and based on the first focus adjustment information.

In contrast, in a case in which the reliability is less than the first threshold, the second focus adjustment information determination unit generates the second focus adjustment information by using the first focus adjustment information without being based on the defocus range. Then, the focus adjustment unit is configured to perform focus adjustment based on the second focus adjustment information.

### First Modified Example of the First Embodiment

In step S1003 and step S1004 in FIG. 5, a focus adjustment information calculation region was set as a region including a plurality of pixels, and a defocus amount was calculated in units of focus adjustment information calculation regions. That is, the focus adjustment information calculation unit calculated focus adjustment information in units of regions including a plurality of pixels of an image included in the image capturing information.

However, the configuration is not limited thereto. For example, a defocus amount may be calculated for each pixel of an image. That is, the focus adjustment information calculation unit may calculate focus adjustment information for each pixel of an image included in the image capturing information. In that case, by performing focus adjustment by using the defocus amount calculated for each pixel, focus adjustment corresponding to detailed changes becomes possible, and more suitable focus detection operation can be realized.

### Second Modified Example of the First Embodiment

Although a defocus amount serving as a candidate to be used for focus adjustment was calculated and determined as first focus adjustment information in step S1005 in FIG. 5, the configuration is not limited thereto. For example, position information of a region in which a defocus amount serving as a candidate is calculated may be determined as the first focus adjustment information. That is, the first focus adjustment information includes position information of a region in which a defocus amount serving as a candidate to be used for focus adjustment is calculated.

In that case, by determining position information of a region in which a defocus amount serving as a candidate is calculated as the first focus adjustment information, a method for determining the first focus adjustment information can be adjusted based on different information, such as image information, that is linked to position information. Thereby, suitable focus detection operation can be realized.

### Third Modified Example of the First Embodiment

In step S1006 in FIG. 5, the defocus range estimation unit 406 estimated the reliability of the defocus range as a continuous value. That is, the reliability of the defocus range was a continuous value. However, the reliability of the defocus range is not limited to a continuous value.

For example, the reliability may be estimated as a discrete value such as 2 in a case in which the reliability of the defocus range is high, 1 in a case in which the reliability is at a medium level, and 0 in a case in which the reliability is low. That is, the reliability of the defocus range may be a discrete value. By making the reliability a discrete value, reduction of a storage region and reduction of calculation cost can be realized.

In addition, even in a scene in which subjects other than the main subject, obstacles, and the like overlap extensively within the main subject region, suitable focus detection operation capable of performing focus adjustment on the main subject can be realized.

### Second Embodiment

In the Second Embodiment, reliability of focus adjustment information is calculated. In addition, the second focus adjustment information is updated according to a ratio of reliability of focus adjustment information used at the time of determining the first focus adjustment information to reliability of the defocus range used at the time of determining the second focus adjustment information.

Then, by adjusting focus based on the updated second focus adjustment information, suitable focus detection operation is realized.

FIG. 14 is a functional block diagram showing a configuration example of an image processing apparatus according to the Second Embodiment. The image processing apparatus 10 according to the Second Embodiment has an image capturing information acquisition unit 1401, a subject region detection unit 1402, a focus adjustment information calculation region determination unit 1403, a focus adjustment information calculation unit 1404, and a first focus adjustment information determination unit 1405. Furthermore, the image processing apparatus 10 is provided with a defocus range estimation unit 1406, a second focus adjustment information determination unit 1407, a second focus adjustment information update unit 1408, and a focus adjustment unit 1409.

However, FIG. 14 is one example of a functional configuration example, and does not limit the scope of the present embodiment. Then, a configuration of an image processing system according to the Second Embodiment is substantially the same as the configuration example in the First Embodiment shown in FIG. 4.

Explanation of functional parts that are the same is omitted. Then, the focus adjustment information calculation unit 1404, the first focus adjustment information determination unit 1405, the second focus adjustment information determination unit 1407, the second focus adjustment information update unit 1408, and the focus adjustment unit 1409, these units being different from the configuration in FIG. 4, are explained.

The focus adjustment information calculation unit 1404 calculates a defocus amount and reliability of the defocus amount based on focus detection image data included in the received image capturing information and the focus adjustment information calculation region. Then, the focus adjustment information calculation unit 1404 outputs a focus adjustment information calculation result to the first focus adjustment information determination unit 1405, the defocus range estimation unit 1406, and the second focus adjustment information determination unit 1407.

The first focus adjustment information determination unit 1405 determines a focus adjustment target part such as a pupil, a face, or a full body, and first focus adjustment information indicating a defocus amount serving as a candidate to be used for focus adjustment, and reliability of the defocus amount. Then, the first focus adjustment information determination unit 1405 outputs the focus adjustment target part and the first focus adjustment information to the second focus adjustment information determination unit 1407 and the second focus adjustment information update unit 1408.

The second focus adjustment information determination unit 1407 determines a defocus amount serving as a candidate to be used for focus adjustment and reliability of the defocus range used at a time of determination as the second focus adjustment information. That is, the second focus adjustment information includes a defocus amount serving as a candidate to be used for focus adjustment. Then, the second focus adjustment information determination unit 1407 outputs the second focus adjustment information to the second focus adjustment information update unit 1408.

The second focus adjustment information update unit 1408 updates the second focus adjustment information based on the first focus adjustment information and the second focus adjustment information. Then, the second focus adjustment information update unit 1408 outputs the updated second focus adjustment information to the focus adjustment unit 1409. The focus adjustment unit 1409 performs focus adjustment based on the received second focus adjustment information.

Next, a processing procedure in the present embodiment is explained. It should be noted that, in order to clarify a difference in processing from FIG. 5 explained in the First Embodiment, for processing that is the same as processing explained in FIG. 5, a corresponding step is described and the explanation thereof is omitted.

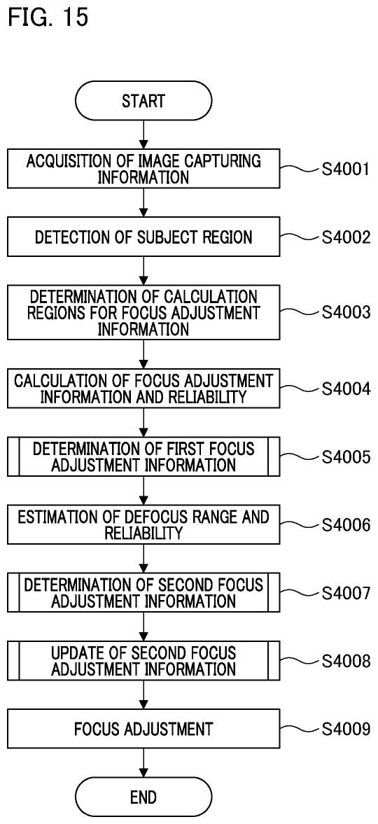

FIG. 15 is a flowchart showing an example of a processing procedure, in the Second Embodiment, for updating second focus adjustment information based on the first focus adjustment information and based on the second focus adjustment information, and performing focus adjustment based on the updated second focus adjustment information.

It should be noted that operations of each step in the flowchart in FIG. 15 are sequentially performed by a CPU or the like serving as a computer within the system control unit 1002 executing a computer program stored in a memory. However, the image processing apparatus 10 does not necessarily need to perform all of the steps explained in this flowchart.

Step S4001, step S4002, and step S4003 are the same as the processing of step S1001, step S1002, and step S1003.

In step S4004, the focus adjustment information calculation unit 1404 calculates, based on focus detection image data included in the received image capturing information and the focus adjustment information calculation region, a defocus amount and reliability, as a continuous value, indicating how much the defocus amount can be trusted.

In addition, in step S4004, a focus adjustment information calculation result is output to the first focus adjustment information determination unit 1405, the defocus range estimation unit 1406, and the second focus adjustment information determination unit 1407, and the processing proceeds to step S4005.

In step S4005, the first focus adjustment information determination unit 1405 determines a focus adjustment target part such as a pupil, a face, or a full body, and first focus adjustment information indicating a defocus amount serving as a candidate to be used for focus adjustment and reliability of the defocus amount. Then, the first focus adjustment information determination unit 1405 outputs the focus adjustment target part and the first focus adjustment information to the second focus adjustment information determination unit 1407 and the second focus adjustment information update unit 1408, and the processing proceeds to step S4006.

Step S4006 is the same as the processing of step S1006.

In step S4007, the second focus adjustment information determination unit 1407 determines a defocus amount serving as a candidate to be used for focus adjustment and reliability of the defocus range used at a time of determination as the second focus adjustment information.

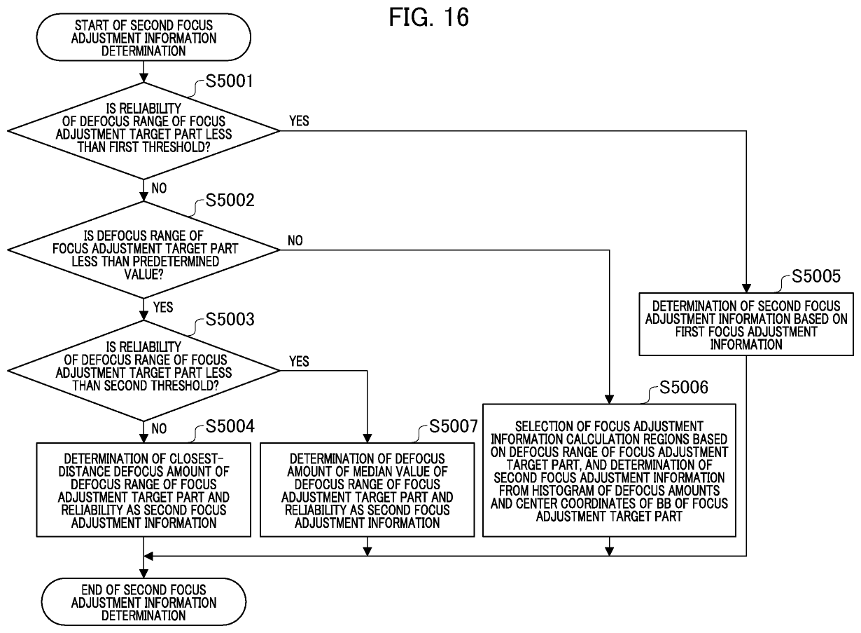

Details of determination of the second focus adjustment information in step S4007 are described below by using FIG. 16. In step S4007, the second focus adjustment information is output to the second focus adjustment information update unit 1408, and the processing proceeds to step S4008.

In step S4008, the second focus adjustment information update unit 1408 updates the second focus adjustment information based on a focus adjustment information calculation result, based on the first focus adjustment information, and based on the second focus adjustment information.

As a method for updating the second focus adjustment information, for example, the second focus adjustment information is updated by a weighted average value that uses a defocus amount of the first focus adjustment information and reliability of the defocus amount, and that uses a defocus amount of the second focus adjustment information and reliability of the defocus range.

That is, by the second focus adjustment information update unit, the second focus adjustment information is updated based on the reliability of focus adjustment information used at a time of determining the first focus adjustment information and based on the reliability of the defocus range used at a time of determining the second focus adjustment information.

Specifically, in a case in which a defocus amount d1 of the first focus adjustment information, reliability p1 of the defocus amount, a defocus amount d2 of the second focus adjustment information, and reliability p2 of the defocus range are set, a weighted average value D is calculated by, for example, Equation 1 below

$$D = \frac{d 1 \times p 1 + d 2 \times p 2}{p 1 + p 2} \qquad ( 1 )$$

That is, the second focus adjustment information is updated by a weighted average value of the first focus adjustment information and the second focus adjustment information, wherein the weighted average value is obtained based on reliability of the focus adjustment information used at a time of determining the first focus adjustment information and based on reliability of the defocus range used at a time of determining the second focus adjustment information.

It should be noted that, although calculation Equation 1 was used here as one example to calculate a weighted average value, there is no constraint on a method for updating the second focus adjustment information. For example, reliability of each focus adjustment information may also be calculated by the focus adjustment information calculation unit, and focus adjustment information to be used for focus adjustment may be determined according to a magnitude of (reliability of the first focus adjustment information/reliability of the second focus adjustment information).

Alternatively, the second focus adjustment information may be updated by using an average value of (defocus amount of the first focus adjustment information/defocus amount of the second focus adjustment information). In step S4008, the updated second focus adjustment information is output to the focus adjustment unit 1409, and the processing proceeds to step S4009.

In step S4009, the focus adjustment unit 1409 performs focus adjustment based on the received second focus adjustment information. As a method for focus adjustment, for example, a focus lens drive amount is calculated based on a defocus amount of the second focus adjustment information.

Then, the focus lens is driven (image capturing control) based on the calculated focus lens drive amount. Then, the processing flow of FIG. 15 ends. By the above-described processing, the second focus adjustment information can be updated based on the first focus adjustment information and based on the second focus adjustment information, and focus adjustment can be performed based on the updated second focus adjustment information. It should be noted that the processing flow of FIG. 15 is executed each time a release button of a camera serving as an image capturing apparatus is pressed, for example.

Next, FIG. 16 is a flowchart showing an example of a processing procedure for performing determination of the second focus adjustment information in step S4007 in the Second Embodiment. It should be noted that operations of each step in the flowchart in FIG. 16 are sequentially performed by a CPU or the like serving as a computer within the system control unit 1002 executing a computer program stored in a memory.

It should be noted that, in FIG. 16, in order to clarify a difference in processing from FIG. 11 explained in the First Embodiment, for processing that is the same as processing explained in FIG. 11, the corresponding step is described and the explanation thereof is omitted.

Step S5001 is the same as the processing of step S3001.

In step S5002, in order to determine whether to determine the second focus adjustment information only from the defocus range of the focus adjustment target part, the second focus adjustment information determination unit 1407 determines whether the defocus range of the focus adjustment target part is a range less than a predetermined value. In a case in which the range is determined to be less than the predetermined value, the processing proceeds to step S5003. In a case in which the range is determined to be equal to or greater than the predetermined value, the processing proceeds to step S5006.

Step S5003 is the same as the processing of step S3002.

In step S5004, the second focus adjustment information determination unit 1407 determines the closest-distance defocus amount within the defocus range of the part that is a focus adjustment target, and the reliability of the defocus range, as the second focus adjustment information.

That is, in a case in which the reliability of the defocus range is greater than the first threshold and is greater than a second threshold that is greater than the first threshold, the closest-distance focus adjustment information of the defocus range is determined as the second focus adjustment information. Then, the processing flow of FIG. 16 ends.

In step S5005, the second focus adjustment information determination unit 1407 determines, as the second focus adjustment information, a defocus amount and reliability of the defocus amount of the first focus adjustment information corresponding to position information of a focus adjustment information calculation region. Then, the processing flow of FIG. 16 ends.

In step S5006, the second focus adjustment information determination unit 1407 performs selection of focus adjustment information calculation regions based on the defocus range of the part that is a focus adjustment target. In addition, the second focus adjustment information determination unit 1407 determines a defocus amount serving as a candidate to be used for focus adjustment and reliability of the defocus amount as the second focus adjustment information from a peak value of a histogram of defocus amounts of each focus adjustment information calculation region after selection and from center coordinates of the BB of the focus adjustment target part. Then, the processing flow of FIG. 16 ends.

In step S5007, the second focus adjustment information determination unit 1407 determines, as the second focus adjustment information, a defocus amount of a median value within the defocus range of the part that is the focus adjustment target and reliability of the defocus range.

That is, in a case in which the reliability of the defocus range is greater than the first threshold, is less than a second threshold that is greater than the first threshold, and the defocus range is less than a predetermined value, the second focus adjustment information is determined based on a statistical value (for example, a median value) of the defocus range.

It should be noted that, although an example of determining a defocus amount of a median value within the defocus range and reliability of the defocus range as the second focus adjustment information was explained here, there is no constraint on a method for determining a defocus amount within the defocus range. A defocus amount may be determined based on a statistical value of the defocus range such as an average value. That is, the above-described statistical value may be an average value of the defocus range. Then, the processing flow of FIG. 16 ends.

By the above-described processing, the second focus adjustment information can be determined by using the second focus adjustment information determination unit 1407.

### (Variation of the Second Embodiment)

Although the focus adjustment information calculation unit 1404 estimated a continuous value as reliability of the defocus amount (each focus adjustment information) in step S4004 in FIG. 15, the configuration is not limited thereto.

For example, the reliability may be estimated as a discrete value such as 2 in a case in which the reliability of the defocus amount (each focus adjustment information) is high, 1 in a case in which the reliability is at a medium level, and 0 in a case in which the reliability is low. By making the reliability a discrete value, reduction of a storage region and reduction of calculation cost can be realized.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image processing apparatus and the like through a network or various storage media. Then, a computer (or a CPU, an MPU, or the like) of the image processing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-076830, filed on May 2, 2025, which is hereby incorporated by reference herein in its entirety.

What is claimed is:

1. An image processing apparatus comprising:
at least one processor; and a memory coupled to the at least one processor, the memory storing instructions that, when executed by the at least one processor, cause the at least one processor to:
acquire image capturing information;
detect a subject region;
calculate a defocus state of the subject region as focus adjustment information;
determine first focus adjustment information based on the subject region and based on the focus adjustment information;
estimate a defocus range of the subject region and a reliability of the defocus range; and
in a case in which the reliability is equal to or greater than a first threshold, perform focus adjustment by using the defocus range and by using the first focus adjustment information, and, in a case in which the reliability is less than the first threshold, perform focus adjustment by using the first focus adjustment information without being based on the defocus range.

2. The image processing apparatus according to claim 1, wherein the memory stores further instructions that, when executed by the at least one processor, cause the at least one processor to:
in a case in which the reliability is equal to or greater than the first threshold, generate second focus adjustment information based on the defocus range and based on the first focus adjustment information, and, in a case in which the reliability is less than the first threshold, generate the second focus adjustment information by using the first focus adjustment information without being based on the defocus range; and
the focus adjustment unit perform the focus adjustment based on the second focus adjustment information.

3. The image processing apparatus according to claim 1, wherein, in detecting the subject region, at least one of a pupil of a subject, a face of the subject, and a full body of the subject is detected as the subject region.

4. The image processing apparatus according to claim 1, wherein, in calculation of the focus adjustment information, the focus adjustment information is calculated for each pixel of an image included in the image capturing information.

5. The image processing apparatus according to claim 1, wherein, in calculation of the focus adjustment information, the focus adjustment information is calculated in units of a region including a plurality of pixels of an image included in the image capturing information.

6. The image processing apparatus according to claim 1, wherein, in calculation of the focus adjustment information, a reliability of each piece of focus adjustment information is also calculated.

7. The image processing apparatus according to claim 6, wherein the reliability of each piece of focus adjustment information is a continuous value.

8. The image processing apparatus according to claim 6, wherein the reliability of each piece of focus adjustment information is a discrete value.

9. The image processing apparatus according to claim 1, wherein, in determining the first focus adjustment information, the first focus adjustment information is determined based on center coordinates of the subject region or based on a histogram of the focus adjustment information.

10. The image processing apparatus according to claim 1, wherein the first focus adjustment information includes a defocus amount serving as a candidate to be used for the focus adjustment.

11. The image processing apparatus according to claim 1, wherein the first focus adjustment information includes position information of a region for which a defocus amount serving as a candidate to be used for the focus adjustment has been calculated.

12. The image processing apparatus according to claim 1, wherein the memory stores further instructions that, when executed by the at least one processor, cause the at least one processor to:
estimate the defocus range of at least one of a pupil of a subject, a face of the subject, and a full body of the subject, and estimates the reliability of the defocus range.

13. The image processing apparatus according to claim 1, wherein the reliability of the defocus range is a continuous value.

14. The image processing apparatus according to claim 1, wherein the reliability of the defocus range is a discrete value.

15. The image processing apparatus according to claim 2, wherein the memory stores further instructions that, when executed by the at least one processor, cause the at least one processor to:
in a case in which the reliability of the defocus range is greater than the first threshold and less than a second threshold that is greater than the first threshold, perform selection of the focus adjustment information based on the defocus range and based on a predetermined value, and determine the second focus adjustment information based on a selection result, based on a histogram of defocus amounts, and based on center coordinates of the subject region.

16. The image processing apparatus according to claim 2, wherein the memory stores further instructions that, when executed by the at least one processor, cause the at least one processor to:
in a case in which the reliability of the defocus range is equal to or greater than a second threshold that is greater than the first threshold, determine the second focus adjustment information based on the defocus range, based on a histogram of defocus amounts, and based on center coordinates of the subject region.

17. The image processing apparatus according to claim 2, wherein the memory stores further instructions that, when executed by the at least one processor, cause the at least one processor to:
in a case in which the reliability of the defocus range is greater than the first threshold and less than a second threshold that is greater than the first threshold, and the defocus range is less than a predetermined value, determine the second focus adjustment information based on a statistical value of the defocus range.

18. The image processing apparatus according to claim 17, wherein the statistical value is a median value of the defocus range.

19. The image processing apparatus according to claim 17, wherein the statistical value is an average value of the defocus range.

20. The image processing apparatus according to claim 2, wherein the memory stores further instructions that, when executed by the at least one processor, cause the at least one processor to:
in a case in which the reliability of the defocus range is greater than the first threshold and is greater than a second threshold that is greater than the first threshold, determine the closest-distance focus adjustment information of the defocus range as the second focus adjustment information.

21. The image processing apparatus according to claim 2, wherein the second focus adjustment information includes a defocus amount serving as a candidate to be used for the focus adjustment.

22. The image processing apparatus according to claim 2, wherein the memory stores further instructions that, when executed by the at least one processor, cause the at least one processor to:
update the second focus adjustment information based on a reliability of the focus adjustment information used in determining the first focus adjustment information and based on the reliability of the defocus range used in determining the second focus adjustment information; and
perform focus adjustment based on the updated second focus adjustment information.

23. The image processing apparatus according to claim 22, wherein the memory stores further instructions that, when executed by the at least one processor, cause the at least one processor to:
update the second focus adjustment information by using a weighted average value of the first focus adjustment information and of the second focus adjustment information, wherein the weighted average value is obtained based on a reliability of the focus adjustment information used in determining the first focus adjustment information and based on the reliability of the defocus range used in determining the second focus adjustment information.

24. An image processing method comprising:
acquiring image capturing information;
detecting a subject region;
calculating a defocus state of the subject region as focus adjustment information;
determining first focus adjustment information based on the subject region and based on the focus adjustment information;
estimating a defocus range of the subject region and a reliability of the defocus range; and
in a case in which the reliability is equal to or greater than a first threshold, performing focus adjustment by using the defocus range and by using the first focus adjustment information, and, in a case in which the reliability is less than the first threshold, performing focus adjustment by using the first focus adjustment information without being based on the defocus range.

25. A non-transitory computer-readable storage medium storing a computer program including instructions for executing the following processes:
acquiring image capturing information;
detecting a subject region;
calculating a defocus state of the subject region as focus adjustment information;
determining first focus adjustment information based on the subject region and based on the focus adjustment information;
estimating a defocus range of the subject region and a reliability of the defocus range; and
in a case in which the reliability is equal to or greater than a first threshold, performing focus adjustment by using the defocus range and by using the first focus adjustment information, and, in a case in which the reliability is less than the first threshold, performing focus adjustment by using the first focus adjustment information without being based on the defocus range.
